(19) United States
(12) Patent Application Publication
(10) Pub. No.: US 2012/0305817 A1
(43) Pub. Date: Dec. 6, 2012

(54) MODULAR FLOW REGULATOR WITH BACKLASH PREVENTION ASSEMBLY

(75) Inventors: Philip M. Burger, Olathe, KS (US); Mark A. Brown, Oak Grove, MO (US); Jimmie L. Robinson, Shawnee, KS (US)

(73) Assignee: BURGER & BROWN ENGINEERING, INC., Grandview, MO (US)

(21) Appl. No.: 13/153,918

(22) Filed: Jun. 6, 2011

(51) Int. Cl. F16K 1/36

(52) U.S. Cl. 251/205; 251/331

(57) ABSTRACT

A flow regulator comprising a needle valve assembly secured in a molded valve body having offset mounting flanges to permit a variety of flow control and monitoring components to be secured thereto. The valve body has parallel inlet and outlet passageways connected by a transverse passageway, with a metal ring forming a valve seat molded into the valve body around the transverse passageway. A valve stem mounted within a valve stem receiver by a support member is selectively advanceable against and away from the valve seat to control flow therethrough. A lateral expander positioned in a slot in the valve stem is compressed axially upon rotation of the valve stem causing the expander to expand in the slot to secure the valve stem in place relative to the support member.

### BACKGROUND OF THE INVENTION

1. Field of the Invention

This invention relates to flow regulators or valves used for controlling the flow of coolant through a cooling circuit such as cooling water circulated through an injection molding system.

2. Description of the Related Art

Needle valves are commonly utilized in flow regulators for circulated water cooling systems used for cooling injection molds and related equipment. Brass has been a preferred material of construction for the bodies of such flow regulators due to its durability, corrosion resistance and relative ease in machining. However, due to rapidly increasing costs for brass, the demand for forming valve bodies from materials less expensive than brass has increased.

It is known to attach flow monitoring or condition sensing components to a flow regulator to monitor flow rates therethrough or sense the temperature or pressure of the coolant flowing into our out of the flow regulator. There is a need for a flow regulator having a design that facilitates attachment of a wide variety of flow monitoring and sensing components to the flow regulator in a variety of configurations depending on the application.

Precise control of the flow of coolant through the cooling circuit is also a desirable feature of a needle valve type flow regulator. However, due to variations in the size of the intermeshing threads of the valve stem and the threaded structure in which the valve stem is supported, such valves are prone to longitudinal movement of the valve stem relative to the support member which is referred to as backlash. Such backlash decreases the ability to precisely control the flow through the valve. There remains a need for an improved valve assembly in which backlash is reduced or minimized.

### SUMMARY OF THE INVENTION

The present invention is directed to a modular flow regulator having a molded valve body with laterally offset mounting flanges formed therein. A wide variety of flow control components, including flow meters, temperature and pressure gauges or the like, are selectively mountable to the offset mounting flanges on either side of the valve body to accommodate varying installation conditions.

The valve body includes inlet and outlet passageways extending in parallel spaced relationship, a transverse flow passageway extending transverse to and connecting the inlet and outlet flow passageways and a valve stem receiver extending in axial alignment with the transverse flow passageway. A valve seat comprising a metal ring is molded into the valve body around the transverse flow passageway and between the inlet and outlet flow passageways.

A valve stem is connected to the valve body through a valve stem mounting member threaded into the valve stem receiver. The valve stem includes an actuating end, a valve seat engaging end or tip and an external thread extending around a portion of the valve stem. The external thread of the valve stem meshes with an internal thread extending around at least a portion of a valve stem receiving bore in said valve stem mounting member. The tip of the valve stem is selectively advanceable into and out of engagement with the valve seat by rotation of the valve stem relative to the valve stem mounting member.

A lateral expander is positioned within a bore or slot in the valve stem. The lateral expander is sized such that an outer edge of the lateral expander is engageable by the internal thread formed around the valve stem receiving bore as the valve stem is rotated relative to the valve stem mounting member. Engagement of the lateral expander by the internal thread compresses the lateral expander axially, causing the lateral expander to expand laterally to engage portions of a wall defining the valve stem bore to secure the position of the valve stem relative to the valve stem mounting member.

### BRIEF DESCRIPTION OF THE DRAWINGS

FIG. 1 is an exploded perspective view showing a plurality of modular flow regulators connected to a manifold and a variety of flow control components.

FIG. 2 is a perspective view of a molded body of the flow regulator.

FIG. 3 is an enlarged cross-sectional view of the molded body taken along line 3-3 of FIG. 2.

FIG. 4 is an enlarged cross-sectional view of the flow regulator taken along line 4-4 of FIG. 1 showing a valve stem assembly secured within the molded body of the flow regulator.

FIG. 5 is an enlarged and exploded view of an alternative embodiment of the valve stem assembly as shown in FIG. 4, including a lateral expander positioned in a slot extending through a valve stem of the valve stem assembly.

FIG. 6 is an enlarged and fragmentary cross-sectional view of the valve stem assembly taken along line 6-6 of FIG. 5.

FIG. 7 is a view similar to FIG. 6 showing an alternative embodiment of the lateral expander.

FIG. 8 is an enlarged, perspective view of the lateral expander shown in the valve stem assembly shown in FIGS. 5 and 6.

FIG. 9 is an enlarged, perspective view of the lateral expander shown in the valve stem assembly of FIG. 7.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

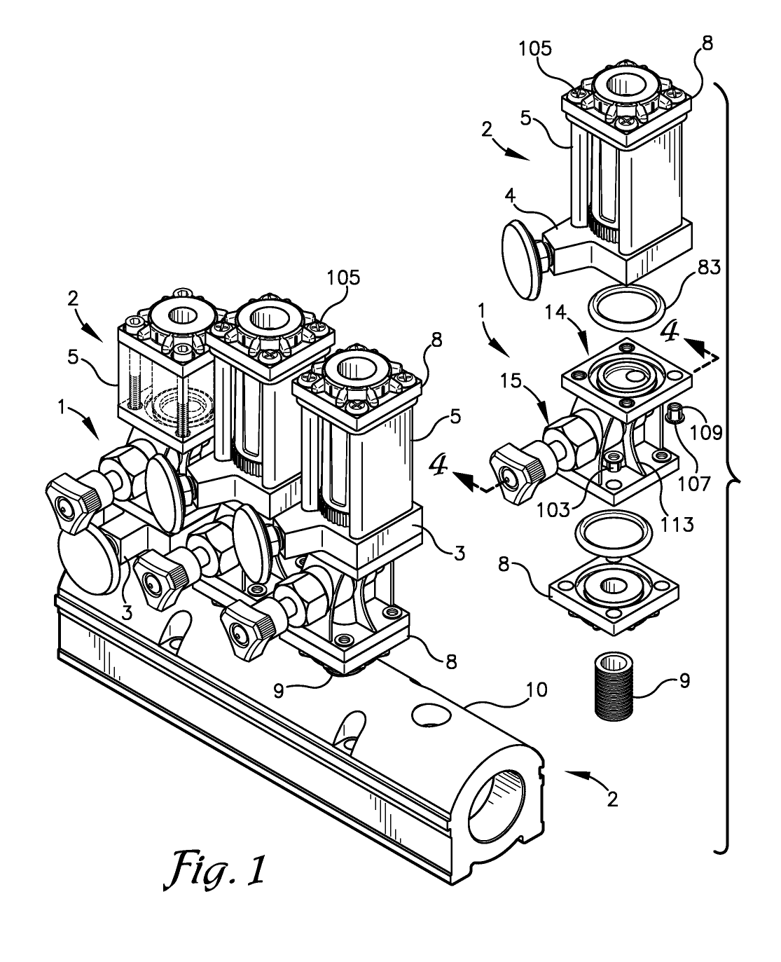

Referring to the drawings in more detail, the reference numeral 1 refers to a flow regulator adapted for controlling the flow of coolant, such as water, through a cooling circuit such as might be used to cool industrial equipment, such an injection mold. The flow regulator 1 is adapted for connection of a wide variety of components thereto for use in controlling or monitoring the flow of coolant through the cooling circuit. Referring to FIG. 1, a variety of such components are shown which may generally be referred to as flow control components 2. Flow control components 2 which may be used with the flow regulator include temperature sensing modules 3, pressure sensing modules 4, flow meters 5 such as the inline flow meter shown, end caps 8 with pipe nipples 9 secured thereto for connecting to manifolds 10 or other conduit.

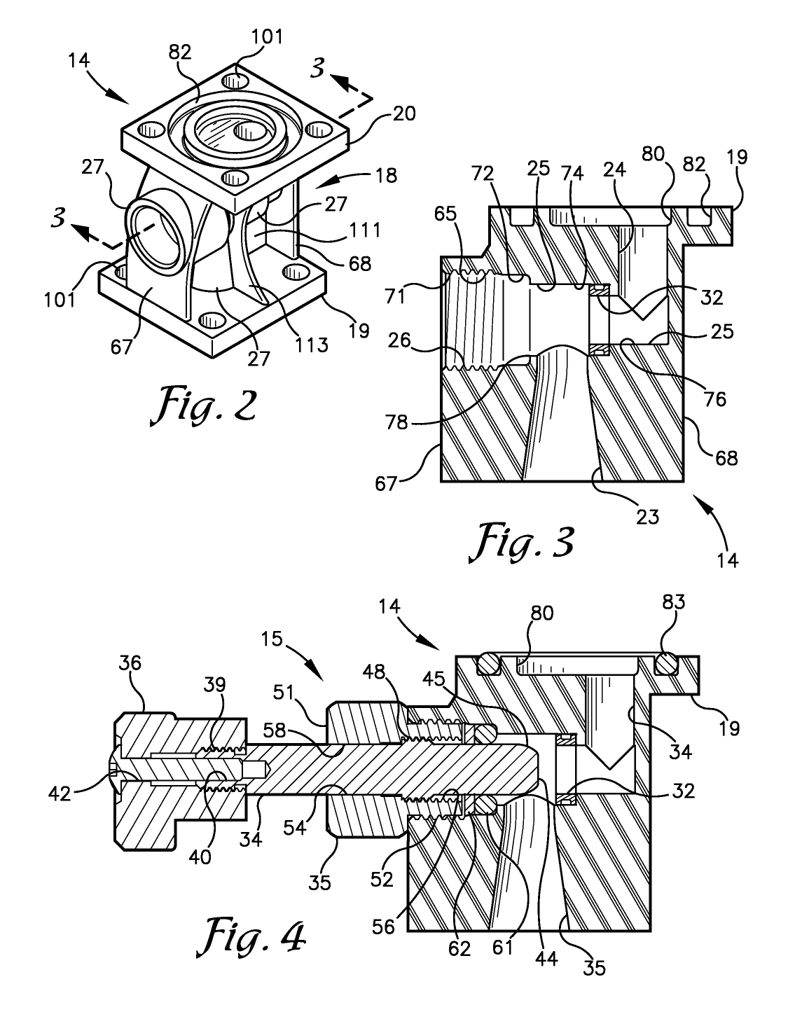

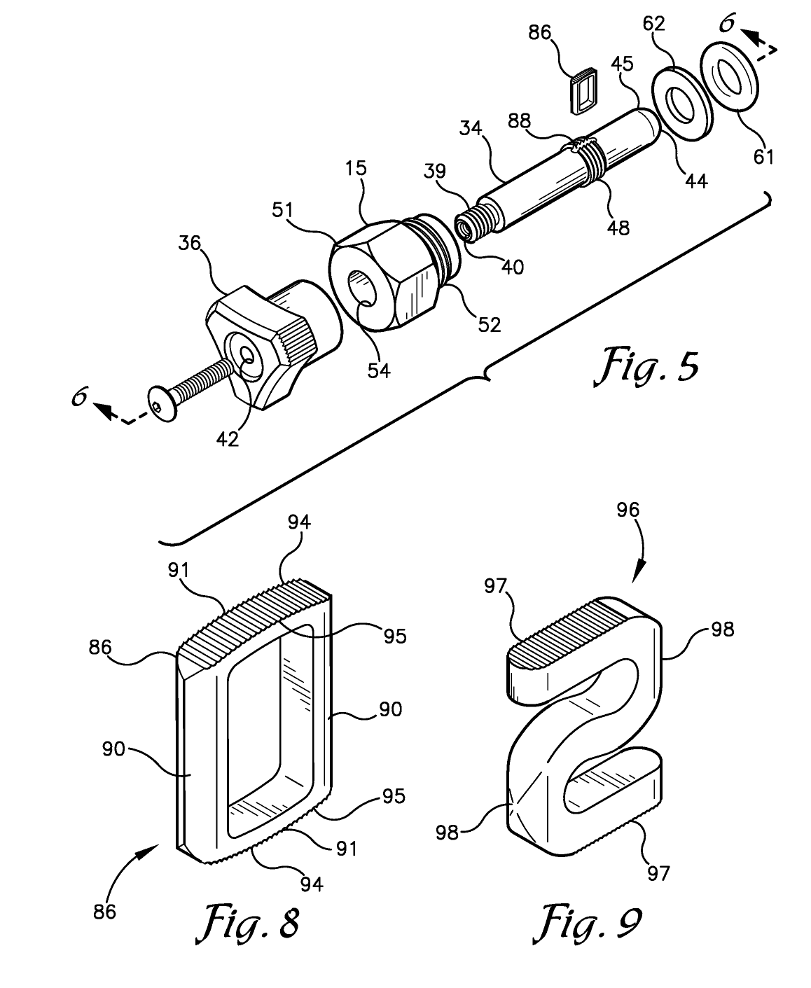

Referring to FIGS. 2-4, the flow regulator or valve assembly 1 comprises a valve body 14 and a valve stem assembly 15 secured to and controlling flow through the valve body 14. The valve body 14 is molded from plastic and comprises a central body 18 with a pair mounting flanges 19 and 20 projecting from opposite ends or the bottom and top of the central body 18 and offset from one another along a longitudinal planar axis through the valve body 14. Inlet and outlet passageways 23 and 24, extending in parallel axial relationship are connected by a transverse connecting passageway 25 that is axially aligned with a valve stem receiver 26 formed in the central body 18. Each of the inlet and outlet passageways 23 and 24, transverse connecting passageway 25 and valve stem receiver 26 is formed within a molded, generally cylindrical or conical wall segment 27 forming the central body 18 and axially oriented on the longitudinal planar axis bisecting the valve body 14. A valve seat 32 formed from a metal ring is molded in the valve body 14 around the transverse connecting passageway 25 and cooperates with the valve stem assembly 15 to control flow between the inlet and outlet passageways 23 and 24.

The valve stem assembly 15 may be described as a needle valve type assembly and is adapted to be secured in the valve stem receiver 26 as described hereafter. The valve stem assembly 15 includes a valve stem 34, a mounting nut 35 and an actuating knob 36. The valve stem 34 and mounting nut 35 may be formed from brass or other suitable material including other metals or plastic. The valve stem 34 is generally cylindrical and elongated. An outer or actuating end 39 of the valve stem 34 is externally threaded around its periphery and includes a threaded bore 40 formed in the end thereof. The actuating knob 36 which includes an internally threaded bore 42 is threadingly coupled to the outer end of the valve stem 34 and held in place by a screw inserted through a hole in the end of knob 36 and threaded into the internally threaded bore 40 in the valve stem outer end 39. A tip 44 of an inner end 45 of the valve stem 34 is beveled for engagement with and movement relative to the valve seat 32 in the valve body 14 to control flow past the valve seat 32.

An externally threaded raised section 48 is formed on the valve stem 34 between its ends. The mounting nut 35 is threaded onto the externally threaded raised section 48 on the valve stem 34. The mounting nut 35 includes an enlarged head 51 and a threaded shank 52. The head 51 is hexagonal for grasping by hand or with a wrench to tighten the nut 35 when connecting it to the valve body 14 as discussed hereafter. An external thread is formed on the outer surface of the threaded shank 52. A bore 54 extends through the nut and an internal thread is formed around a portion or section 56 of the bore 54 extending through the threaded shank 52 and partially through the head 51. The remaining portion or section 58 of the bore 54 extending through the head 51 of the nut 35 is not threaded. The externally threaded raised section 48 of the valve stem 34 is threadingly coupled to and within the internally threaded section 56 of the bore 54 through the mounting nut 35. When the mounting nut 35 is secured to the valve body 14, rotation of the valve stem 15 relative to the nut 35, using knob 36, causes the tip 44 of the valve stem 34 to move relative to the valve seat 32. A resilient O-ring 61 and a more rigid back-up ring 62 are mounted on the valve stem 34 between the mounting nut 35 and the tip 44 of the valve stem 34 for sealing the valve stem receiver 26 from the transverse connecting passageway 25 as discussed hereafter.

Referring to FIG. 3, the transverse connecting passageway 25 and valve stem receiver 26 are formed as part of a transverse bore 65 extending into the valve body 14 and intersecting with the inlet and outlet passageways 23 and 24. The transverse bore 65 is open at a first end of the valve body 14 proximate a first end wall 67 and is divided into a plurality of segments of reduced diameter as the bore 65 approaches a second end wall 68 of the valve body 14. The segments of reduced diameter include an internally threaded inlet section 71 extending from the open end inward to an O-ring receiving section 72 of slightly reduced diameter. The threaded inlet section 71 and O-ring receiving section 72 form the valve stem receiver 26. Past the O-ring receiving section 72, the transverse bore 65 narrows forming an intermediate section 74 and then narrows again forming an inner section 76. The intermediate and inner sections 74 and 76 of the transverse bore 65 form the transverse connecting passageway 25.

The metal ring forming the valve seat 32 is molded into the valve body 14 around the transverse connecting passageway 25 at the intersection of the intermediate section 74 and the inner section 76. The inner diameter of the metal ring is smaller than the inner diameter of the intermediate section 74 to form the valve seat 32 engageable by the tip 44 of the valve stem 34 to control the flow of coolant therethrough. A shoulder 78 formed between the O-ring receiving section 72 and the intermediate section 74 provides a surface against which the O-ring 61 abuts and is compressed for forming a seal between the valve stem receiver 26 and the intermediate section 74 of the transverse bore 65.

The inlet passageway 23, which is generally frusto-conical in shape, connects to or opens into the intermediate section 74 of the transverse bore 65 at a right angle thereto. Similarly, the outlet passageway 24 connects to or opens out of the inner section 76 of the transverse bore 65 at a right angle thereto such that an axis of the outlet passageway 24 extends parallel to an axis of the inlet passageway 23. An outlet section 80 of the outlet passageway 24 expands in diameter at an outer end thereof and within the top mounting flange 20 and is offset from a main section of the outlet passageway 24 such that the outlet of the outlet passageway 24 is generally centered relative to the top flange 20. An O-ring receiving groove 82 is formed in an upper surface of the top flange 20 around the outlet section 80 of the outlet passageway 24 and an O-ring 83 (See FIG. 1) is secured therein forming a water tight seal with any flow control components 2 connected thereto.

The valve stem assembly 15 is secured in the valve body 14 by inserting the tip 44 of the valve stem 34 into the transverse bore 65 so that the tip 44 extends into the intermediate section 74 and then threading the threaded shank 52 of the mounting nut 35 into the threaded inlet section 71 of the transverse bore 65. The mounting nut 35 is preferably drawn or threaded forward on the valve stem 34 before threading the nut 35 into the inlet section 71 of the transverse bore 65 so that the tip 44 of the valve stem 34 does not engage the valve seat 32 before the mounting nut 35 is fully threaded into the threaded inlet section 71 of the valve body 14. When the mounting nut 35 is fully threaded into the threaded inlet section 71, an inner end of the mounting nut shank 52 compresses the back-up ring 62 and the O-ring 61 against the shoulder 78 formed between the inlet section 71 and the intermediate section 74 of the transverse bore 65. The compressed O-ring 61 expands radially to form a seal around the valve stem 34 while also forming a seal against the shoulder 78 so that water does not leak through the valve stem assembly 15 and out the transverse bore 65.

Rotation of the valve stem 34 using the knob 36 moves the tip 44 of the valve stem 34 into and out of engagement with the valve seat 32 to control the flow of water past the valve seat 32 from the inlet passageway 23 to the outlet passageway 24. The tip 44 of the valve stem 34 is beveled or conically shaped which permits relatively fine control of the volume of water flowing past the valve seat 32 depending on the degree of separation of the valve stem tip 44 from the valve seat 32.

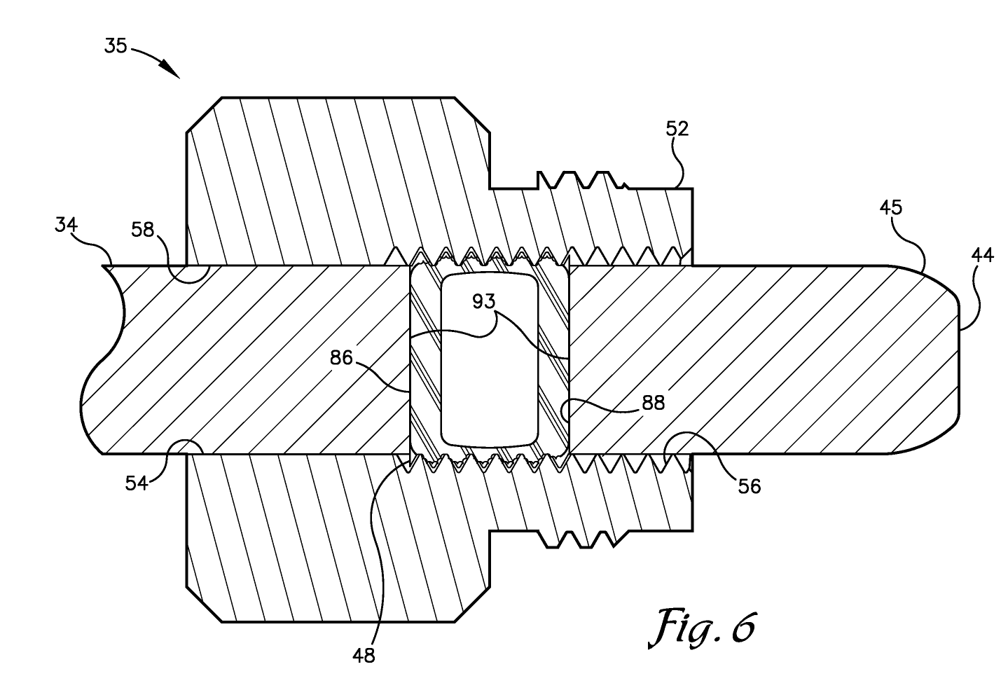

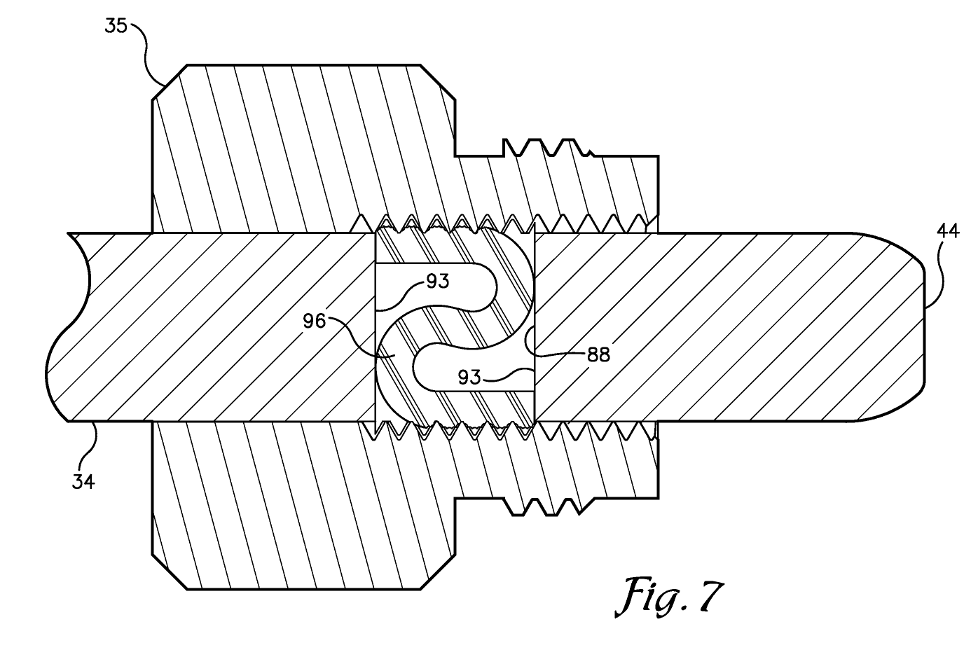

Referring to FIGS. 5-7, to reduce the effects of backlash resulting from play between the external thread on the raised section 48 of the valve stem 34 and the internal thread in mounting nut 35, a lateral expander or spring 86 may be positioned or secured within a slot 88 formed through the externally threaded raised section 48 of the valve stem 34. The lateral expander 86 is preferably formed from a plastic such as acetal and may be formed of a plastic that is softer than the brass forming the valve stem 34 and mounting nut 35. In the embodiment shown in FIGS. 5, 6 and 8, the lateral expander 86 is generally formed as a rectangular ring with straight sides 90 and arcuate ends 91. The arcuate ends 91 or outer edges of the lateral expander 86 extend into the path of the exterior thread on the raised section 48 of the valve stem 34. When the internal thread of the mounting nut 35 is threaded onto or over the exterior thread of the raised section 48 of the valve stem 34, the internal thread engages the arcuate ends 91 and compresses the lateral expander 86 within the slot 88 causing the lateral expander 86 to expand laterally relative to the slot 88 pressing the straight sides 90 of the lateral expander 86 against sidewalls 93 forming the slot 88 to produce a tight fit relative thereto.

An outer surface of each of the arcuate ends 91 of the lateral expander 86, preferably include a plurality of closely spaced ridges 94 with shallow grooves 95 therebetween which help guide the internal thread of the mounting nut 35 over the lateral expander 86 and provide a relatively rough surface to resist sliding of the mounting nut internal thread relative to the arcuate ends 91 of the lateral expander 86. In addition, the lateral expander 86 is preferably sufficiently soft relative to the mounting nut internal thread such that the internal thread digs into the lateral expander 86 further resisting movement of the valve stem 34 relative to the nut 35.

Referring to FIGS. 7 and 9, an alternative lateral expander 96 is shown. The alternative embodiment is generally S-shaped having outer legs 97 and a pair of bends 98. When compressed, the S-shape causes the outer edges of the bends 98 and the ends of each leg 97 to expand longitudinally relative to the slot 88 to press against the internal edges of the slot sidewalls 93 to resist sliding of the valve stem 34 relative to the mounting nut 35.

Referring again to the valve body 14 as shown in FIG. 2, the mounting flanges may also be referred to as inlet mounting flange 19 and outlet mounting flange 20. The mounting flanges 19 and 20 extend outwards from the sides of the central body 18 and in the preferred embodiment are square. A mounting hole 101 is formed in each corner of each mounting flange extending from an outer surface to an inner surface thereof. In the outlet mounting flange 20, the mounting holes 101 are formed radially outward from the O-ring groove 82. As seen in FIG. 1, a threaded annular insert 103 may be secured in each of the mounting holes 101 to facilitate coupling of flow control components to the flanges 19 and 20 using threaded fasteners 105. The inserts 103 preferably include an enlarged head 107 and a stem 109 which is internally threaded and incorporates knurling or gripping means on an outer surface for gripping the flange around the mounting hole 101 to prevent it from rotating within the hole 101. The threaded annular insert 103 is positioned in the mounting hole 101 such that the enlarged head 107 extends across and engages an inner surface of the mounting flange to prevent the threaded insert 103 from being pulled outward through the hole 101 when a fastener 105 is threaded therethrough for mounting a flow control component from an opposite side thereof. It is understood that the threaded annular inserts 103 could be inserted with the enlarged heads 107 engaging the outer surface of the flange in which they are inserted.

Structural support for the valve body and the mounting flanges is further provided by integral webbing 111 extending between the cylindrical wall segments 27 and the mounting flanges 19 and 20 in combination with the end walls 67 and 68 and central gussets or ribs 113 extending between the mounting flanges 19 and 20. The first end wall 67 extends between the mounting flanges 19 and 20 on the first end of the valve body 14 with the cylindrical wall segment 27 for the valve stem receiver 26 projecting through the first end wall 67. The first end wall 67 curves from a first end of the inlet mounting flange 19 to a first end of the outlet mounting flange 20. The second end wall 68 extends vertically between the mounting flanges 19 and 20 on the second end of the valve body 14 from a second end of the inlet mounting flange 19 to a bottom of the outlet mounting flange 20 inwardly spaced from a second end thereof.

As indicated previously, the outlet mounting flange 20 is offset from the inlet mounting flange 19 such that the second end of the outlet mounting flange 20 extends past or overhangs the second end of the inlet mounting flange 19. Similarly, the first end of the inlet mounting flange 19 extends past or outward relative to the first end of the outlet mounting flange 20. The inserts 103 in the inlet mounting flange 19 along the first edge are accessible generally directly above and access thereto is not obstructed by the outlet mounting flange 20. Similarly, access to the inserts 103 in the outlet mounting flange 20 along the second edge is not obstructed by the inlet mounting flange 19.

Each of the flow control components 2 preferably incorporates a four bolt hole arrangement sized and spaced to conform to the size, spacing and location of the four mounting holes 101 in the inlet and outlet mounting flanges 19 and 20 of the flow regulator 1. The flow control components 2 can be bolted to either mounting flange 19 or 20 depending on the flow configuration and functionality desired.

It is to be understood that while certain forms of the present invention have been illustrated and described herein, it is not to be limited to the specific forms or arrangement of parts described and shown. As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

Having thus described the invention, what is claimed as new and desired to be secured by Letters Patent is as follows:

1. A flow regulator comprising:
a) a molded valve body including:
i) an inlet passageway and an outlet passageway extending in parallel spaced relationship;
ii) a valve seat between said inlet and outlet passageways;
iii) an inlet mounting flange on an inlet end of and projecting outward from said valve body;
iv) an outlet mounting flange on an outlet end of and projecting outward from said valve body; said outlet mounting flange offset laterally from said inlet mounting flange;
v) said inlet passageway having an inlet opening extending through said inlet mounting flange;
vi) said outlet passageway having an outlet extending through said outlet mounting flange;
b) a valve stem secured in said valve body and selectively engaging said valve seat to control the flow of fluid between said inlet and outlet flow passageways.

2. The flow regulator as in claim 1 wherein said inlet opening is centered relative to said inlet mounting flange and said outlet opening is centered relative to said outlet mounting flange.

3. The flow regulator as in claim 1 wherein said inlet and outlet mounting flanges are square.

4. The flow regulator as in claim 1 wherein said inlet and outlet mounting flanges each includes at least three fastener receivers therein.

5. The flow regulator as in claim 1 wherein said valve seat comprises a metal ring molded into said molded valve body.

6. The flow regulator as in claim 1 further comprising:
a) a transverse flow passageway extending transverse to and connecting said inlet and outlet flow passageways; said valve seat comprising a metal ring molded into said valve body around said transverse flow passageway and between said inlet and outlet flow passageways;
b) a valve stem receiver extending in axial alignment with said transverse flow passageway; said valve stem secured in said valve stem receiver with said valve stem positioned for selected advancement of a valve stem tip into and out of engagement with said valve seat.

7. A valve stem assembly for a valve having a valve body comprising:
a) a valve stem mounting member connectable to said valve body; said valve stem mounting member having a valve stem receiving bore extending therethrough;
b) a valve stem having an actuating end, a valve seat engaging end and an external thread extending around at least a portion of said valve stem; said valve stem positioned in said valve stem receiving bore of said valve stem mounting member such that said valve stem external thread meshes with an internal thread extending around at least a portion of said valve stem receiving bore; and
c) a lateral expander positioned within a bore in said valve stem; said lateral expander sized such that an outer edge of said lateral expander is engageable by said internal thread formed around said valve stem receiving bore as said valve stem is rotated relative to said valve stem mounting member; engagement of said lateral expander by said internal thread compresses said lateral expander axially causing said lateral expander to expand laterally to engage portions of a wall defining said valve stem bore to secure the position of said valve stem relative to said valve stem mounting member.

8. The valve stem assembly as in claim 7 wherein said bore in said valve stem extends through said valve stem and transverse to an axis thereof, and said lateral expander is sized such that opposite outer edges of said lateral expander are engageable by said internal thread formed around said valve stem receiving bore as said valve stem is rotated relative to said valve stem mounting member to compress said lateral expander axially causing said lateral expander to expand laterally.

9. The valve stem assembly as in claim 8 wherein said lateral expander is formed from a material that is softer than said internal thread around said valve stem receiving bore.

10. The valve stem assembly as in claim 8 wherein said lateral expander receiving bore comprises a slot and said lateral expander comprises a ring having a pair of spaced apart legs and cross members connecting said legs on opposite ends thereof and said outer edges of said lateral expander engageable by said internal thread of said valve stem receiving bore comprise outer edges of said cross members.

11. The valve stem as in claim 8 wherein said outer edges of said lateral expander have a plurality of serrations formed therein.

12. The valve stem assembly as in claim 8 wherein said lateral expander receiving bore comprises a slot and said lateral expander is S-shaped having a pair of spaced apart legs on opposite ends thereof.

13. A flow regulator comprising:
a) a molded valve body including an inlet passageway and an outlet passageway extending in parallel spaced relationship, a transverse flow passageway extending transverse to and connecting said inlet and outlet flow passageways and a valve stem receiver extending in axial alignment with said transverse flow passageway;
b) a valve seat comprising a metal ring molded into said valve body around said transverse flow passageway and between said inlet and outlet flow passageways;
c) a valve stem mounting member connectable to said molded valve body; said valve stem mounting member having a valve stem receiving bore extending therethrough;
d) a valve stem having an actuating end, a valve seat engaging end and an external thread extending around at least a portion of said valve stem; said valve stem positioned in said valve stem receiving bore of said valve stem mounting member such that said valve stem external thread meshes with an internal thread extending around at least a portion of said valve stem receiving bore; said valve seat engaging end of said valve stem selectively advanceable into and out of engagement with said valve seat by rotation of said valve stem relative to said valve stem mounting member; and
e) a lateral expander positioned within a bore in said valve stem; said lateral expander sized such that an outer edge of said lateral expander is engageable by said internal thread formed around said valve stem receiving bore as said valve stem is rotated relative to said valve stem mounting member; engagement of said lateral expander by said internal thread compresses said lateral expander axially causing said lateral expander to expand laterally to engage portions of a wall defining said valve stem bore to secure the position of said valve stem relative to said valve stem mounting member.

14. The flow regulator as in claim 13 wherein said molded valve body further comprises:
a) an inlet mounting flange on an inlet end of and projecting outward from said valve body; and
b) an outlet mounting flange on an outlet end of and projecting outward from said valve body; said outlet mounting flange offset laterally from said inlet mounting flange.

15. The flow regulator as in claim 14 wherein said inlet passageway includes an inlet opening centered on said inlet mounting flange; and said outlet passageway includes an outlet opening centered on said outlet mounting flange.

16. The flow regulator as in claim 14 wherein said inlet and outlet mounting flanges are square.

17. The flow regulator as in claim 14 wherein said inlet and outlet mounting flanges each includes at least three fastener receivers therein.

18. A flow regulator comprising:
a) a valve body molded from plastic and including an inlet passageway and an outlet passageway, a connecting passageway extending between and connecting said inlet and outlet passageways and a valve stem receiver opening into said connecting passageway;
b) a valve seat comprising a metal ring molded into said valve body around said connecting passageway and between said inlet and outlet passageways;
c) a valve stem mounted in said valve stem receiver and having a valve seat engaging end selectively advanceable into and out of engagement with said valve seat.

19. The flow regulator as in claim 18 wherein said inlet and outlet passageways extend in parallel relationship and said connecting passageway extends transverse to said inlet and outlet passageways.

20. The flow regulator as in claim 18 wherein said valve stem receiver is axially aligned with said connecting passageway.
